(19) United States
(12) Patent Application Publication
(10) Pub. No.: US 2019/0387111 A1
(43) Pub. Date: Dec. 19, 2019

(54) IMAGE FORMING APPARATUS, IMAGE FORMING SYSTEM, CONTROL METHOD AND NON-TRANSITORY COMPUTER-READABLE RECORDING MEDIUM ENCODED WITH CONTROL PROGRAM

(71) Applicant: Konica Minolta, Inc., Tokyo (JP)

(72) Inventor: Minako KOBAYASHI, Osaka (JP)

(21) Appl. No.: 16/433,301

(22) Filed: Jun. 6, 2019

(30) Foreign Application Priority Data
Jun. 14, 2018 (JP) 2018-113656

(51) Int. Cl. H04N 1/00

(52) U.S. Cl. CPC H04N 1/00403; H04N 1/00925; H04N 1/00923

(57) ABSTRACT

An image forming apparatus includes a hardware processor, the hardware processor determining a job, and in the case where the job is to be controlled in response to acceptance of an instruction to control the job, even when the instruction to control the job is accepted based on speech, if the job is determined not based on speech, not controlling the job.

### CROSS REFERENCE TO RELATED APPLICATION

The present application claims priority under 35 U.S.C. § 119 to Japanese patent Application No. 2018-113656 filed on Jun. 14, 2018, is incorporated herein by reference in its entirety.

### BACKGROUND

### Technological Field

The present invention relates to an image forming apparatus, an image forming system, a control method and a non-transitory computer-readable recording medium encoded with a control program. Specifically, the present invention relates to an image forming apparatus that executes a job that is input by speech, an image forming system including the image forming apparatus, a control method that is performed in the image forming apparatus and a non-transitory computer-readable recording medium encoded with a control program for allowing the computer to perform the control method.

### Description of the Related Art

In recent years, accuracy of speech recognition technique has been improved, and a Multi Function Peripheral (hereinafter referred to as an “MFP”) can be operated using speech. The operation performed using speech is easier and can be input in a shorter period of time as compared to the operation using an operation panel. In the meantime, whether the operation is performed using speech or the operation panel is left to a user. Therefore, a job may be input by speech, or may be input not by speech but by using the operation panel.

For example, Japanese Patent Laid-Open No. 2016-35514 describes an image forming apparatus characterized by comprising an accepting means for accepting an instruction for a first job using a speech input means, an execution means for executing the first job or a second job received from an information processing apparatus, a determination means, in the case where the accepting means accepts the first job, for determining whether a second job in execution is present, a reply means, in the case where determination is made that the second job in execution is present, for interrupting the second job and replying whether the first job is to be put in, and a control means, in the case where an instruction to interrupt is received with respect to the reply using the speech input means, for controlling interruption of the second job, restarting the interrupted second job and putting in the first job.

Meanwhile, the user may wish to stop execution of a job after inputting the job in the MFP. Also in the case where the user instructs the MFP to stop the execution of the job, there are two types of operations, e.g. an operation using speech and an operation using an operation panel. In the case where an operation of stopping execution of the job is input by speech, the MFP stops the job in execution. However, in the case where the user who has instructed the job in execution by the MFP is different from the user who has instructed a stop of execution, there is a problem that the MFP may unnecessarily stop the job halfway through the execution.

### SUMMARY

According to one aspect of the present invention, an image forming apparatus includes a hardware processor, the hardware processor determining a job, and in the case where the job is to be controlled in response to acceptance of an instruction to control the job, even when the instruction to control the job is accepted based on speech, if the job is determined not based on speech, not controlling the job.

According to another aspect of the present invention, an image forming system includes a plurality of image forming apparatuses, and an instruction acceptor that accepts an instruction, wherein a hardware processor included in each of the plurality of the image forming apparatuses determines a job, and in the case where the job is to be controlled in accordance with the accepted instruction, when the instruction is accepted based on speech, if the job is determined not based on speech, does not control the job.

According to yet another aspect of the present invention, a control method performed in an image forming apparatus, includes a determination step of determining a job, and a job control step of controlling the job in response to acceptance of an instruction to control the job, wherein the job control step, in the case where the instruction is accepted based on speech, when the job is determined not based on speech, includes not controlling the job.

According to yet another aspect of the present invention, a control method performed in an image forming system including a plurality of image forming apparatuses and an instruction acceptor that accepts an instruction, includes allowing each of the plurality of image forming apparatuses to perform a determination step of determining a job, and a job control step of controlling the job in accordance with the accepted instruction, wherein the job control step, in the case where the instruction is accepted based on speech, when the job is determined not based on speech, includes not controlling the job.

According to yet another aspect of the present invention, a non-transitory computer-readable recording medium encoded with a control program executed by a computer controlling an image forming apparatus, the computer, by executing the control program, determines a job, and in the case where the job is to be controlled in response to acceptance of an instruction to control the job, when the instruction is accepted based on speech, if the job is determined not based on speech, does not control the job.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram showing an overview of an image forming system in a first embodiment of the present invention;

FIG. 2 is a block diagram showing an outline of a hardware configuration of an MFP;

FIG. 3 is a block diagram showing one example of functions of a CPU included in the MFP in the first embodiment;

FIG. 4 is a flow chart showing one example of a flow of a device management process in the first embodiment;

FIG. 5 is a first flow chart showing one example of a flow of a job control process;

FIG. 6 is a second flow chart showing the one example of the flow of the job control process;

FIG. 7 is a flow chart showing one example of a flow of a job accepting process;

FIG. 8 is a block diagram showing one example of functions of a CPU included in an MFP in a second modified embodiment;

FIG. 9 is a diagram showing an overview of an image forming system in a second embodiment; and

FIG. 10 is a flow chart showing one example of a flow of a device management process in the second embodiment.

### DETAILED DESCRIPTION OF EMBODIMENTS

Hereinafter, one or more embodiments of the present invention will be described below with reference to the drawings. However, the scope of the invention is not limited to the disclosed embodiments. In the following description, the same parts are denoted with the same reference characters. Their names and functions are also the same. Thus, a detailed description thereof will not be repeated.

### First Embodiment

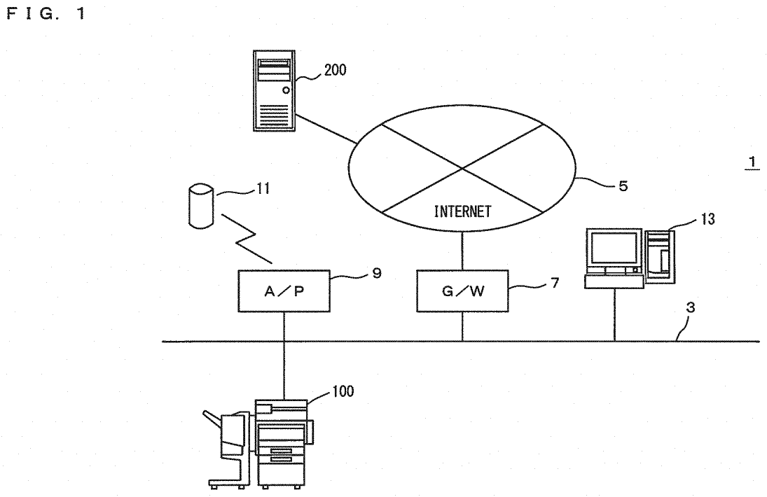

FIG. 1 is a diagram showing an overview of an image forming system in a first embodiment of the present invention. Referring to FIG. 1, an image forming system 1 includes an MFP (Multi Function Peripheral) 100, a personal computer (hereinafter referred to as a “PC”) 13, a smart speaker 11 and a cloud server 200.

The MFP 100 is one example of the image forming apparatus. The PC 13 is a general computer, and its hardware configuration is well known. Therefore, a detailed description thereof will not be repeated. The MFP 100 and the PC 13 are respectively connected to a network 3. The network 3 is a local area network (LAN), for example. Therefore, the MFP 100 and the PC 13 can communicate with each other via the network 3. For example, in the PC 13, a printer driver program for controlling the MFP 100 is installed. The PC 13 can control the MFP 100 and allow the MFP 100 to execute a print job by executing the printer driver program. The network 3 may be either wired or wireless. Further, the network 3 may be a wide area network (WAN), a public switched telephone networks (PSTN), the Internet or the like.

The smart speaker 11 includes a microphone, a speaker and a wireless LAN interface. The smart speaker 11 functions as an output device that outputs speech from the speaker and an input device that accepts speech collected by the microphone. An access point (AP) 9 is a relay device having a wireless communication function and connected to the network 3. The smart speaker 11 is connected to the network 3 by communicating with the access point AP9. Thus, the smart speaker 11 can communicate with the MFP 100 and the PC 13.

A gateway (G/W) device 7 is connected to the network 3 and the Internet 5. The gateway device 7 relays the communication between the network 3 and the Internet 5. The cloud server 200 is connected to the Internet 5. Therefore, the MFP 100, the PC 13 and the smart speaker 11 can respectively communicate with the cloud server 200 via the gateway device 7.

The cloud server 200 functions as an AI (Artificial Intelligence) assistant for the smart speaker 11. The AI assistant included in the cloud server 200 is registered in the smart speaker 11 in advance. The smart speaker 11 converts the speech collected by the microphone into speech data, which is electronic data, and transmits the speech data to the cloud server 200. Further, the smart speaker 11 converts the electronic data transmitted from the cloud server 200 into speech and outputs the speech from the speaker.

The cloud server 200 uses the smart speaker 11 as a user interface, performs natural language processing of the speech that is uttered by a user and collected by the smart speaker 11, and determines an optimal solution based on an instruction that is derived as a result of speech recognition. The AI assistant included in the cloud server 200 may use deep learning in determining an optimal solution. The cloud server 200 executes a process that is determined as the optical solution.

Further, the cloud server 200 has a user identification function. In the cloud server 200, a voiceprint of the user who operates the smart speaker 11 is registered in the cloud server 200 in association with the smart speaker 11. The cloud server 200 compares the speech collected by the smart speaker 11 with the registered voiceprint of the user and identifies the user based on the speech. In this manner, the cloud server 200 identifies the user who has input an instruction by the speech based on the speech collected by the smart speaker 11.

Further, in the cloud server 200, an application program that controls the MFP 100 is installed, and the application program is registered in association with a predetermined instruction. The cloud server 200 specifies an instruction based on the speech uttered by the user, and executes the application program associated with the specified instruction.

Here, a print instruction is associated with a first application program, and a stop instruction is associated with a second application program, by way of example. The first application program defines the process of allowing the MFP 100 to execute a print job, and the second application program defines the process of stopping a job that is in execution by the MFP 100.

For example, in the first application program, a location for storage of the print job and a device that executes the print are registered in advance with respect to the user. In this case, when specifying the user and the print instruction based on the speech collected by the smart speaker 11, the cloud server 200 executes the first application program in accordance with the specified print instruction. In this case, the cloud server 200 allows the device that is registered with respect to the user to execute the print job that is stored in the location that is registered with respect to the user who is identified based on the speech collected by the smart speaker 11.

For example, a predetermined folder in the cloud server 200 is registered as the location for storage of a print job with respect to a user A, and the MFP 100 is registered as the device that executes the print, by way of example. In the case where the user A utters the print instruction to the speaker 11, the cloud server 200 specifies the user A and the print instruction based on the speech collected by the smart speaker 11. Then, the cloud server 200 executes the first application program associated with the print instruction, transmits the print job stored in the predetermined folder in the cloud server 200 registered with respect to the user A to the MFP 100 that is registered with respect to the user A, and allows the MFP 100 to execute the print job. Therefore, for example, when producing a print job in the PC 13, storing the print job in the predetermined folder in the cloud server 200, and then inputting the print instruction in the smart speaker 11 by speech, the user A can allow the MFP 100 to execute the print job. In this case, the print job includes the user identification information for identifying the user who has input the print instruction.

Although the predetermined folder in the cloud server 200 is registered as the location for storage of the print job in this case, the location for storage of the print job is not limited to the cloud server 200 but may be another computer such as a print server.

The MFP 100 is registered in the second application program in advance. In this case, the cloud server 200 executes the second application program in accordance with a stop instruction specified by the speech collected by the smart speaker 11, and transmits a stop signal for allowing the MFP 100 to stop the execution of the print job to the MFP 100. In the case where specifying the stop instruction based on the speech collected by the smart speaker 11, when being able to specify the user based on the speech, the cloud server 200 transmits a stop signal including user identification information for identifying the specified user. In the case where specifying the stop instruction based on the speech collected by the smart speaker 11, when being unable to specify the user based on the speech, the cloud server 200 transmits a stop signal not including the user identification information.

The operations of the AI assistant included in the cloud server 200 and the application programs registered in the cloud server 200 are not limited to the above-mentioned operations, but may be other operations.

A printer driver for controlling the MFP 100 is installed in the PC 13. Therefore, the user can operate the PC 13 and allow the MFP 100 to execute a print job. In this case, the print job includes the user identification information of the user who operates the PC 13. Further, in the case where having a speech recognition function, the PC 13 can produce a print job or transmit the print job based on the speech uttered by the user. In the case where the PC 13 transmits the print job to the MFP 100, if at least one of the operation of producing the print job and the operation of transmitting the print job is accepted based on the speech uttered by the user, the PC adds additional information indicating that the instruction was given based on the speech and transmits the print job. Further, in the case where producing the print job, the PC 13 may store the print job in the predetermined folder in the cloud server 200.

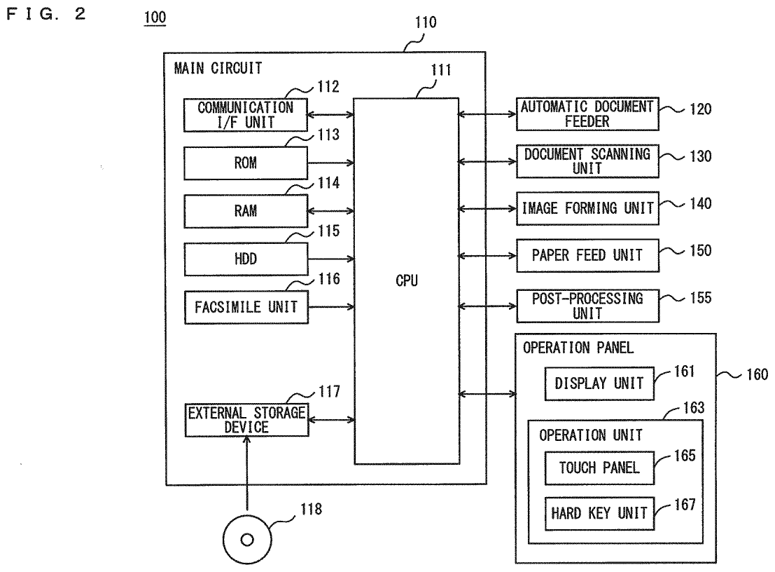

FIG. 2 is a block diagram showing an outline of the hardware configuration of the MFP. Referring to FIG. 2, the MFP 100 includes a main circuit 110, a document scanning unit 130 for scanning a document, an automatic document feeder 120 for conveying a document to the document scanning unit 130, an image forming unit 140 for forming an image on a paper (a sheet of paper) or the like based on image data that is output by the document scanning unit 130 that has scanned a document, a paper feed unit 150 for supplying the paper to the image forming unit 140, a post-processing unit 155 for processing the paper on which an image is formed and an operation panel 160 serving as a user interface.

The post-processing unit 155 performs a sort process of sorting and discharging one or more sheets of paper on which images have been formed by the image forming unit 140, a hole-punching process of punching the sheets, and a stapling process of stapling the sheets.

The main circuit 110 includes a CPU 111, a communication interface (I/F) unit 112, a ROM 113, a RAM 114, a hard disk drive (HDD) 115 as a mass storage device, a facsimile unit 116, and an external storage device 117 on which a CD-ROM 118 is mounted. The CPU 111 is connected to the automatic document feeder 120, the document scanning unit 130, the image forming unit 140, the paper feed unit 150, the post-processing unit 155 and the operation panel 160, and controls the MFP 100 as a whole.

The ROM 113 stores a program to be executed by the CPU 111 or data necessary for execution of the program. The RAM 114 is used as a work area when the CPU 111 executes the program. Further, the RAM 114 temporarily stores scan data (image data) successively transmitted from the document scanning unit 130.

The communication I/F unit 112 is an interface for connecting the MFP 100 to the network 3. The CPU 111 communicates with the PCs 200, 200A, 200B, 200C via the communication I/F unit 112, and transmits data to and receives data from the PCs 200, 200A, 200B, 200C via the communication I/F unit 112. Further, the communication I/F unit 112 can communicate with a computer connected to the Internet 5 via the network 3.

The facsimile unit 116 is connected to the public switched telephone networks (PSTN) and transmits facsimile data to or receives facsimile data from the PSTN. The facsimile unit 116 stores the received facsimile data in the HDD 115 or outputs the received facsimile data to the image forming unit 140. The image forming unit 140 prints the facsimile data received by the facsimile unit 116 on the paper. Further, the facsimile unit 116 converts the data stored in the HDD 115 into facsimile data, and transmits the facsimile data to a facsimile machine connected to the PSTN.

The external storage device 117 is mounted with the CD-ROM (Compact Disk ROM) 118. The CPU 111 can access the CD-ROM 118 via the external storage device 117. The CPU 111 loads a program, recorded in the CD-ROM 118 which is mounted on the external storage device 117, into the RAM 114 for execution. It is noted that the medium for storing the program to be executed by the CPU 111 is not limited to the CD-ROM 118. It may be an optical disc (MO (Magnetic Optical Disc)/MD (Mini Disc)/DVD (Digital Versatile Disc)), an IC card, an optical card, and a semiconductor memory such as a mask ROM or an EPROM (Erasable Programmable ROM).

Further, the program to be executed by the CPU 111 is not restricted to the program recorded in the CD-ROM 118, but CPU 111 may load a program, stored in the HDD 115, into RAM 114 for execution. In this case, another computer connected to the network 3 may rewrite the program stored in the HDD 115 of the MFP 100, or may additionally write a new program therein. Further, the MFP 100 may download a program from another computer connected to the network 3 and store the program in the HDD 115. The program referred to here includes not only a program directly executable by the CPU 111 but also a source program, a compressed program, an encrypted program or the like.

The operation panel 160 is provided on an upper surface of the MFP 100 and includes a display unit 161 and an operation unit 163. For example, the display unit 161 is a liquid crystal display device (LCD) or an organic EL (Electro-Luminescence) display and displays an instruction menu to the user, information about the acquired image data, etc. The operation unit 163 includes a touch panel 165 and a hard key unit 167. The touch panel 165 is superimposed on the upper surface or the lower surface of the display unit 161. The hard key unit 167 includes a plurality of hard keys. The hard keys are contact switches, for example. The touch panel 165 detects a position designated by the user in the display surface of the display unit 161. In the case where operating the MFP 100, the user is likely to be in an upright attitude, so that the display surface of the display unit 161, an operation surface of the touch panel 165 and the hard key unit 167 are arranged to face upward. This is for the purpose of enabling the user to easily view the display surface of the display unit 161 and easily give an instruction using the operation unit 163 with his or her finger.

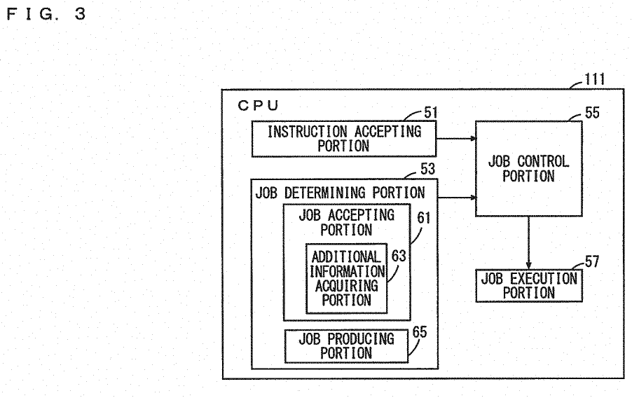

FIG. 3 is a block diagram showing one example of functions of the CPU included in the MFP in the first embodiment. The functions shown in FIG. 3 are formed in the CPU 111 when the CPU 111 included in the MFP 100 executes a control program stored in the ROM 113, the HDD 115 or the CD-ROM 118. Referring to FIG. 3, the CPU 111 includes an instruction accepting portion 51, a job determining portion 53, a job control portion 55 and a job execution portion 57.

The job execution portion 57 controls hardware resources and executes a job. The hardware resources include the communication I/F unit 112, the HDD 115, the facsimile unit 116, the automatic document feeder 120, the document scanning unit 130, the image forming unit 140, the paper feed unit 150, the post-processing unit 155 and the operation panel 160. For example, the jobs include a copy job, a print job, a scan job, a facsimile transmission job and a data transmission job. The jobs that can be executed by the job execution portion 57 are not limited to these, but may include other jobs. The copy job includes a process of allowing the document scanning unit 130 to scan a document and a process of allowing the image forming unit 140 to form an image based on the data that is output by the document scanning unit 130 that has scanned a document. The print job includes a process of allowing the image forming unit 140 to form an image of data stored in the HDD 115 or an image of a print job that is externally received by the communication I/F unit 112 on the paper. The scan job includes a process of allowing the document scanning unit 130 to scan a document and a process of allowing the HDD 115 to store the data that is output by the document scanning unit 130 that has scanned a document. The facsimile transmission job includes a process of allowing the document scanning unit 130 to scan a document and a process of allowing the facsimile unit 116 to transmit the data that is output by the document scanning unit 130 that has scanned a document. The data transmission job includes a process of controlling the communication I/F unit 112 and transmitting the data stored in the HDD 115 or the data that is output by the document scanning unit 130 that has scanned a document to another computer.

The job determining portion 53 determines a job to be executed by the job execution portion 57. The job determining portion 53 includes a job accepting portion 61 that externally accepts jobs and a job producing portion 65 that produces jobs based on operations input by the user. The job determining portion 53 outputs a job accepted by the job accepting portion 61 or a job produced by the job producing portion 65 to the job control portion 55.

In the case where the communication I/F unit 112 receives a print job from the cloud server 200, the job accepting portion 61 accepts the received print job from the cloud server 200. In the case where the job accepting portion 61 accepts the received print job from the cloud server 200, the job determining portion 53 associates the print job with additional information. The additional information indicates that the execution of the print job has been instructed by speech.

Further, in the case where the communication I/F unit 112 receives a print job from the PC 13, the job accepting portion 61 accepts the print job that has been received from the PC 13. The job accepting portion 61 includes an additional information acquiring portion 63. In the case where the communication I/F unit 112 receives the additional information together with the print job from the PC 13, the additional information acquiring portion 63 acquires the additional information that is received together with the print job. In the case where the additional information acquiring portion 63 acquires the additional information, the job determining portion 53 associates the print job that is received together with the additional information with the additional information.

In the case where the user inputs an operation in the operation unit 163, the job producing portion 65 produces a job in accordance with the accepted operation. In the case where specifying a user who operates the operation unit 163, the job producing portion 65 produces a job including user identification information for identifying the user.

The instruction accepting portion 51 accepts a stop instruction. The stop instruction is the instruction to stop the job in execution by the job execution portion 57. The instruction accepting portion 51 outputs a stop instruction to the job control portion 55 in response to acceptance of the stop instruction. The stop instruction includes a speech instruction given by speech and an operation instruction accepted by the operation panel 160. In the case where the communication I/F unit 112 receives a stop signal from the cloud server 200, the instruction accepting portion 51 accepts a speech instruction. In the case where the operation unit 163 accepts an operation of designating the key associated with the stop instruction, the instruction accepting portion 51 accepts an operation instruction. In the case where a stop signal is received from the cloud server 200, when the stop signal includes user identification information, the instruction accepting portion 51 outputs a speech instruction including the user identification information to the job control portion 55. In the case where a stop instruction is received from the cloud server 200, when the stop signal does not include the user identification information, the instruction accepting portion 51 outputs a speech instruction not including the user identification information to the job control portion 55.

The job control portion 55 controls a job to be executed by the job execution portion 57. The job control portion 55 allows the job execution portion 57 to execute a job that has been determined in the job determining portion 53. The job control portion 55 allows the job execution portion 57 to execute the received jobs in the order in which the jobs are received from the job determining portion 53. In the case where the job execution portion 57 is executing another job when the job control portion 55 receives a job from the job determining portion 53, the job control portion 55 adds the job that has been received from the job determining portion 53 to a wait line. In response to end of the execution of the job that is in execution by the job execution portion 57, the job control portion 55 allows the job execution portion 57 to execute the job, which is set to be executed first, out of the one or more jobs that are set in the wait line.

In the case where a stop instruction is received from the instruction accepting portion 51, when the stop instruction is a speech instruction, the job control portion 55 stops the execution of the job on the condition that the job in execution by the job execution portion 57 is associated with additional information. Specifically, in the case where a speech instruction is received from the instruction accepting portion 51, when the job in execution by the job execution portion 57 is not associated with additional information, the job control portion 55 does not stop the execution of the job.

Further, in the case where a speech instruction includes user identification information, even when a job in execution by the job execution portion 57 is not associated with additional information, if the job is associated with the user identification information that is the same as the user identification information included in the speech instruction, the job control portion 55 stops the execution of the job. Therefore, the job control portion 55 can stop the execution of the job that has been input by the user who has input the stop instruction by speech.

Further, in the case where accepting a speech instruction from the instruction accepting portion 51, when a job in execution by the job execution portion 57 is associated with additional information, the job control portion 55 stops the execution of the job. However, even in the case where the job in execution is associated with the additional information, when a stop signal includes user identification information, if the user identification information included in the job in execution is different from the user identification information included in the stop signal, the job control portion 55 does not stop the execution of the job. The job control portion 55 can be prevented from stopping the execution of the job, production or execution of which has been instructed by another user who is different from the user who has input the stop instruction by speech.

A job associated with additional information is the job that has been produced based on speech or the job, execution of which has been instructed by speech. The speech instruction is a stop instruction that is input in the smart speaker 11 by speech. Compared to an operation instruction, the time required for the user to travel to operate the operation panel 160 and the time required for the user to designate corresponding keys out of the plurality of keys included in the operation panel 160 are not required when an instruction is input by speech. Thus, it takes a shorter period of time to complete the operation. Thus, execution of the job can be stopped earlier. Further, regarding the input of jobs, some users may prefer to input jobs using the operation panel 160, and the execution of the job, that has been input by another user who is different from the user who has input a speech instruction, can be prevented from being stopped.

Further, in the case where the job control portion 55 stops execution of a job in accordance with a speech instruction, when a job not associated with additional information is set in a wait line, the job control portion 55 allows the job execution portion 57 to execute the job. The job that is set in the wait line can be executed earlier, and the time required for the user who has input the job to wait can be shortened. In the case where a plurality of jobs not associated with additional information are set in the wait line, the job control portion 55 allows the job execution portion 57 to execute the job that is set in the wait line the earliest.

In the case where the job control portion 55 receives a stop instruction from the instruction accepting portion 51, when the stop instruction is an operation instruction, the job control portion 55 stops the job in execution by the job execution portion 57. Specifically, in the case where accepting an operation instruction from the instruction accepting portion 51, the job control portion 55 stops execution of the job regardless of whether the job in execution by the job execution portion 57 is associated with additional information. The operation instruction is an instruction that is input by a user's operation in the operation unit 160. Therefore, the user who has input the operation instruction is operating the MFP 100 and can view the job in execution by the MFP 100.

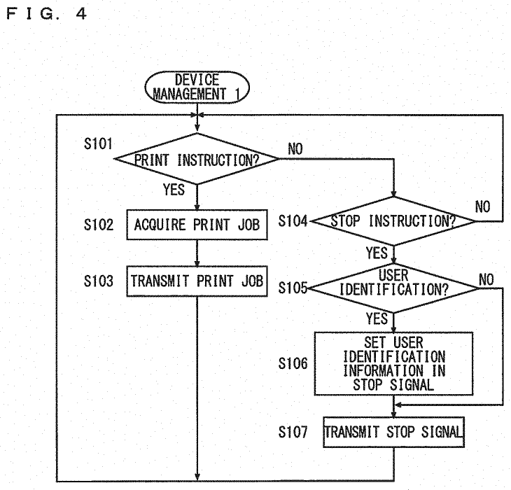

FIG. 4 is a flow chart showing one example of a flow of a device management process in the first embodiment. The device management process is executed by the CPU 201 when the CPU 201 included in the cloud server 200 executes the first application program and the second application program. Referring to FIG. 4, a task that executes the AI assistant selects a print instruction or a stop instruction in the CPU 201. The CPU 201 determines whether a print instruction has been selected by the task that executes the AI assistant (step S101). If the print instruction has been selected, the process proceeds to the step S102. If not, the process proceeds to the step S104. In the step S104, the CPU 201 determines whether a stop instruction has been selected by the task that executes the AI assistant. If the stop instruction is selected, the process proceeds to the step S105. If not, the process returns to the step S101.

In the step S102, the CPU 201 acquires a print job stored in the location that is registered in advance with respect to the first application program. Then, the CPU 201 transmits a print job to the device registered in advance with respect to the first application program, i.e. the MFP 100 in this example (step S103), and the process returns to the step S101.

In the step S105, the CPU 201 determines whether a user has been identified by the task of executing the AI assistant. If the user is identified, the process proceeds to the step S106. If not, the process proceeds to the step S107. In the step S106, the CPU 201 sets the user identification information of the user who is identified in the step S105 in a stop signal, and the process proceeds to the step S107. In the step S107, the CPU 201 transmits the stop signal to the MFP 100, and the process returns to the step S101. In the step S107, in the case where the step S106 is not performed, the CPU 201 transmits a stop signal not including user identification information to the MFP 100. In the step S107, in the case where the step S106 is performed, the CPU 201 transmits a stop signal including user identification information to the MFP 100.

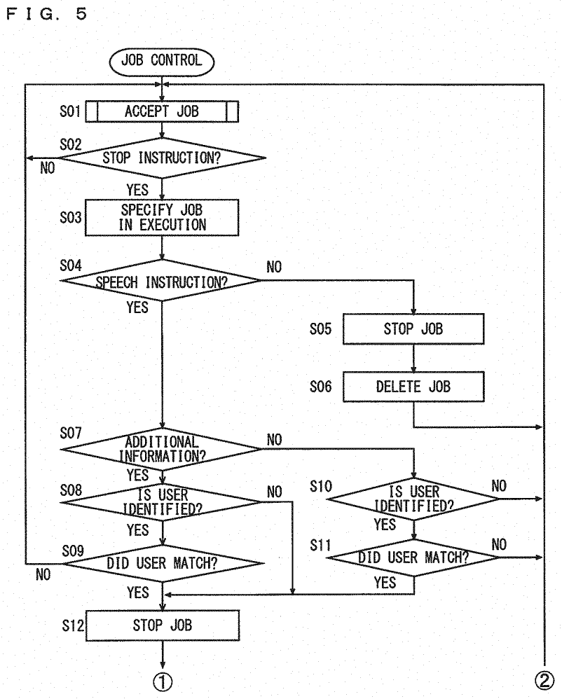

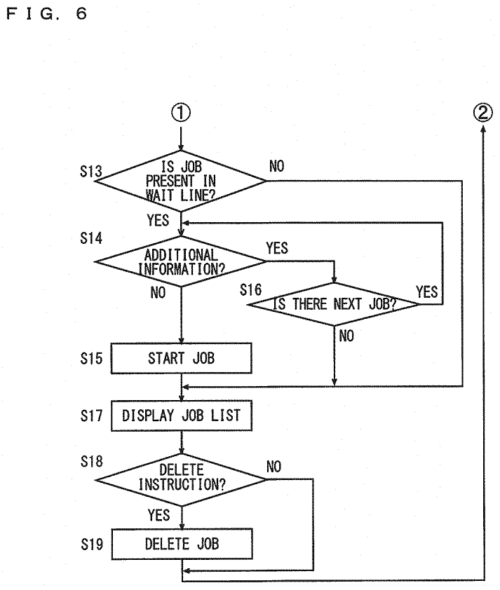

FIG. 5 and FIG. 6 are first flow charts showing one example of a flow of a job control process. The job control process is the process executed by the CPU 111 when the CPU 111 included in the MFP 100 executes a job control program stored in the ROM 113, the HDD 115 or the CD-ROM 118. Referring to FIG. 5 and FIG. 6, the CPU 111 included in the MFP 100 executes a job accepting process (step S01), and the process proceeds to the step S02. The job accepting process, which will be described below in detail, is the process of accepting a job that is input by the user.

In the next stop S02, the CPU 111 determines whether a stop instruction has been accepted. If the stop instruction is accepted, the process proceeds to the step S03. If not, the process returns to the step S01. The stop instruction may be accepted when the CPU 111 receives a stop signal from the cloud server 200. Also, the stop instruction may be accepted by the operation unit 163 when the user operates the operation unit 163. The stop instruction that is accepted when the CPU 111 receives the stop signal from the cloud server 200 is a speech instruction, and the stop instruction accepted by the operation unit 163 with the user operating the operation unit 163 is an operation instruction. In the case where the user inputs a stop instruction by speech to the smart speaker 11, the cloud server 200 transmits the stop signal to the MFP 100. Further, in the case where the user can be identified by the speech collected by the smart speaker 11, the cloud server 200 transmits the stop signal including the user identification information of the user who has given the stop instruction. In the case where the user cannot be identified by the speech collected by the smart speaker 11, the cloud server 200 transmits the stop signal not including the user identification information of the user who has given the stop instruction.

In the step S03, the CPU 111 specifies the job in execution as a process to be executed. Then, the CPU 111 determines whether the stop instruction is a speech instruction (step S04). If the stop instruction is a speech instruction, the process proceeds to the step S07. If not, the process proceeds to the step S05. In the step S05, the CPU 111 stops execution of the job specified as the job to be executed, and the process proceeds to the step S06. In the case where the stop instruction is an operation instruction, the user is operating the MFP 100. Thus, the user can view the job in execution by the MFP 100. In this case, the MFP 100 immediately stops the job in execution by the MFP 100. In the step S06, the MFP 100 deletes the job specified as the job to be executed, and the process returns to the step S01.

In the step S07, the CPU 111 determines whether the job specified as the job to be executed is associated with additional information. If the job is associated with the additional information, the process proceeds to the step S08. If not, the process proceeds to the step S10. The additional information is the information associated with a job in the job accepting process. In the case where a job is produced based on speech, or the case where execution of the job is instructed by speech, the job is associated with additional information.

In the step S08, the CPU 111 determines whether the user who has input a stop instruction has been identified. If the user who has instructed a stop of execution of a job is identified, the process proceeds to the step S09. If not, the process proceeds to the step S10. In the step S02, the stop instruction is accepted. In the case where a stop signal is received from the cloud server 200, if the user identification information is included in the stop signal, the CPU 111 determines that the user who has instructed the stop has been identified.

In the step S09, the CPU 111 determines whether the user who has instructed the execution of the job that is specified as the job to be executed matches the user who has input the stop instruction. If the users match, the process proceeds to the step S12. If not, the process returns to the step S01.

In the case where the process proceeds from the step S09 to the step S12, the CPU 111 stops the execution of the job specified as the job to be executed in the step S12, and the process proceeds to the step S13. In the case where the job specified as the job to be executed is associated with additional information, in other words, the case where the job specified as the job to be executed is produced based on speech or the case where the instruction to execute the job that is specified as the job to be executed is given by speech, execution of the job is stopped. However, even in the case where the job that is specified as the job to be executed is produced based on speech or the case where the instruction to execute the job that is specified as the job to be executed is given by speech, when the user who has instructed the execution of the job does not match the user who has input the stop instruction, the process returns to the step S01. Thus, the step S12 is not performed, and the execution of the job is not stopped. Thus, execution of the job, production or execution of which has been instructed by another user who is not the user who has input the stop instruction, can be prevented from being stopped.

The process proceeds to the step S10 in the case where the job specified as the job to be executed is not associated with additional information. In the step S10, whether the user who has instructed the stop has been identified is determined. If the user who has instructed the stop is identified, the process proceeds to the step S11. If not, the process returns to the step S01. In the step S11, the CPU 111 determines whether the user who has instructed execution of the job that is specified as the job to be executed matches the user who has input the stop instruction. If the users match, the process proceeds to the step S12. If not, the process returns to the step S01.

In the case where the process proceeds from the step S11 to the step S12, the execution of the job that is specified as the job to be executed is stopped in the step S12, and the process proceeds to the step S13. Even in the case where the job specified as the job to be executed is not the job, the production or execution of which has been instructed by speech, when the user who has instructed the execution of the job matches the user who has input the stop instruction, the execution of the job is stopped. However, even in the case where the production or execution of the job that is specified as the job to be executed has been instructed not by speech, when the user who has instructed the execution of the job does not match the user who has input the stop instruction, the process returns to the step S01. Therefore, the step S12 is not performed, and the execution of the job is not stopped. Thus, execution of the job, production or execution of which has been instructed not by speech by another user who is not the user who has input the stop instruction, can be prevented from being stopped.

In the step S13, the CPU 111 determines whether a job is set in a wait line. If a job is set in the wait line, the process proceeds to the step S14. If not, the process proceeds to the step S17. In the step S14, the CPU 111 determines whether a job that is set in the wait line to be executed first is associated with additional information. If the job is associated with the additional information, the process proceeds to the step S15. If not, the process proceeds to the step S16. In the step S15, the CPU 111 determines whether the job that is to be executed next is set in the wait line. If the job that is to be executed next is set, the process returns to the step S14. If not, the process proceeds to the step S17. In the case where the process proceeds from the step S16 to the step S14, the processes of the step S14 and subsequent steps are performed on the job to be executed next. In the step S15, execution of the job set in the wait line is started, and the process proceeds to the step S17. Therefore, the job that is to be executed the earliest out of the jobs, which are set in the wait line and not associated with additional information, is executed. Therefore, the job, production or execution of which has been instructed by speech, can be prevented from being executed.

In the step S17, a job list is displayed in the display unit 161. The job list is the screen for displaying the job, execution of which is stopped in the step 12, the jobs set in the wait line and the jobs that are in execution in the case where the step S15 is performed, in a selectable manner. In the next step S18, the CPU 111 determines whether a delete instruction has been accepted. If the delete instruction has been received, the process proceeds to the step S19. If not, the step S19 is skipped, and the process returns to the step S01. The delete instruction includes the instruction to select one or more jobs included in the job list displayed in the display unit 161 in the step S17 and an instruction to delete the selected job. In the step S19, the CPU 111 deletes the job that is selected by the delete instruction, and the process returns to the step S01. In the case where the job the execution of which is stopped in the step S12 is not deleted, the job execution of which has been stopped may be added to the wait line to be the first job to be executed.

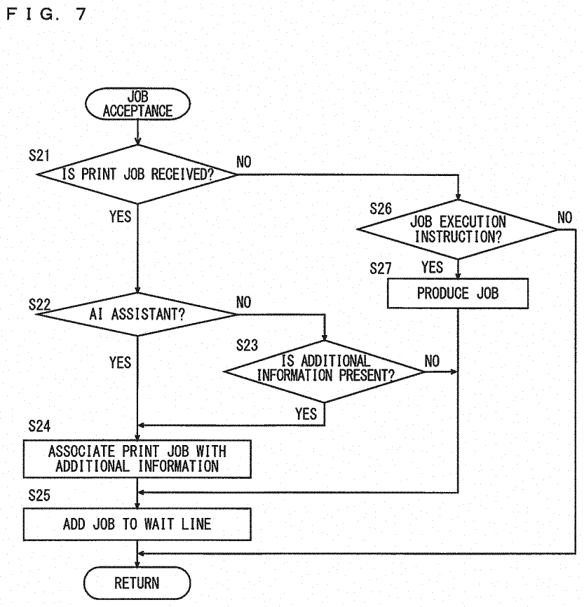

FIG. 7 is a flow chart showing one example of a flow of the job accepting process. The job accepting process is performed in the step S01 of FIG. 5. Referring to FIG. 7, the CPU 111 determines whether a print job has been received (step S21). The CPU 111 determines whether the communication I/F unit 112 has externally received a print job. If the communication I/F unit 112 has received a print job, the process proceeds to the step S22. If not, the process proceeds to the step S26. Here, a print job is received from either the cloud server 200 or the PC 13, by way of example.

In the step S22, the CPU 111 determines whether the print job has been transmitted from the AI assistant included in the cloud server 200. If the print job has been received from the AI assistant, the process proceeds to the step S24. If not, the process proceeds to the step S23. In the step S24, the CPU 111 associates the print job received from the cloud server 200 with additional information, and the process proceeds to the step S25. The process proceeds to the step S23 in the case where the print job is received from the PC 13. In the step S23, the CPU 111 determines whether additional information has been received together with the received print job. If the additional information has been received, the process proceeds to the step S24. If not, the process proceeds to the step S25. In the step S24, the CPU 111 associates the print job that has been received from the PC 13 with additional information, and the process proceeds to the step S25. In the case where the process proceeds from the step S23 to the step S25, the CPU 111 does not associate the print job that has been received from the PC 13 with the additional information.

On the other hand, in the step S26, the CPU 111 determines whether a job execution instruction has been accepted. An instruction to execute a job is accepted in accordance with an operation input by the user in the operation unit 163. If an instruction to execute a job is accepted, the process proceeds to the step S27. If not, the process returns to the job control process. In the step S27, a job is produced in accordance with an operation input by the user, and the process proceeds to the step S25.

In the step S25, the CPU 111 sets a print job received in the step S21 or a job produced in the step S27 in the wait line by adding them to the wait line, and the process returns to the job control process. The jobs set in the wait line are executed in the order in which the jobs are set.

### First Modified Example

The MFP 100 in the first embodiment temporarily stops the jobs in execution by the job execution portion 57, and displays the job list in the display unit 161 in order to enable the user to select a job to be deleted from among the jobs in execution by the job execution portion 57 and jobs that are waiting to be executed. Alternatively, in the case where the MFP 100 can be remotely operated by an information processing apparatus, the user may operate the information processing apparatus and select a job to be deleted. The information processing apparatus is a mobile information device such as a smartphone carried by a user or an information terminal that is provided to be operable by a plurality of users.

### Second Modified Example

In the CPU 111 included in the MFP 100, the program for executing a speech recognition process of recognizing speech and a user identification process of identifying the user who has uttered the speech may be installed. In this case, a microphone and a speaker may be included in the MFP 100 instead of the smart speaker 11. Alternatively, the MFP 100 may control the smart speaker 11 and input and output speech. Thus, the CPU 111 included in the MFP 100 can produce or execute a job based on the speech uttered by the user, and can accept a stop instruction based on the speech uttered by the user.

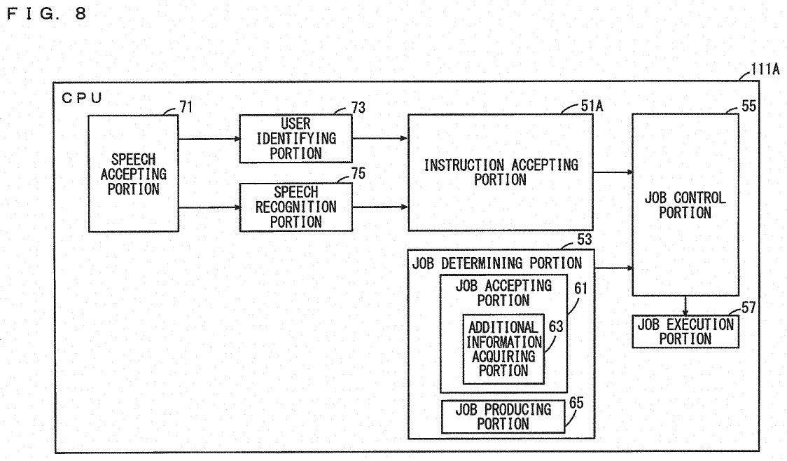

FIG. 8 is a block diagram showing one example of functions of a CPU included in an MFP in a second modified example. The functions shown in FIG. 8 are different from the functions shown in FIG. 3 in that a speech accepting portion 71, a user identifying portion 73 and a speech recognition portion 75 are added, and that the instruction accepting portion 51 is changed to an instruction accepting portion 51A. The other functions are the same as the functions shown in FIG. 3. Therefore, a description thereof will not be repeated.

The speech accepting portion 71 controls a speaker, converts the speech collected by the speaker into speech data, which is electronic data, and outputs the speech data to the user identifying portion 73 and the speech recognition portion 75. The user identifying portion 73 compares the speech data to the pre-registered voiceprint of the user, and specifies the user corresponding to the speech data. In the case where specifying the user corresponding to the speech data, the user identifying portion 73 outputs the user identification information of the specified user to the instruction accepting portion 51A.

The speech recognition portion 75 carries out speech recognition of the speech data, and converts the speech data into the character information. The speech recognition portion 75 outputs character information to the instruction accepting portion 51A.

The instruction accepting portion 51A accepts a stop instruction. The stop instruction is the instruction to stop the job in execution by the job execution portion 57. In response to acceptance of the stop instruction, the instruction accepting portion 51A outputs the stop instruction to the job control portion 55. The stop instruction includes a speech instruction given by speech, and an operation instruction accepted in the operation panel 160.

In the instruction accepting portion 51A, character information relating to the stop instruction is registered in advance. In the case where the character information received from the speech recognition portion 75 matches the character information registered in relation to the stop instruction, the instruction accepting portion 51 accepts the speech instruction. In the case where receiving user identification information from the user identifying portion 73, the instruction accepting portion 51A outputs the speech instruction including the user identification information to the job control portion 55. Further, in the case where the operation unit 163 accepts an operation of instructing the stop, the instruction accepting portion 51A accepts an operation instruction.

### Second Embodiment

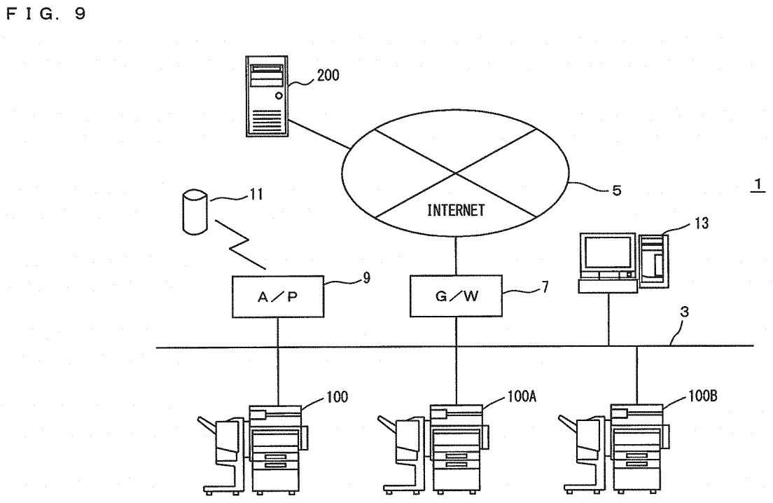

FIG. 9 is a diagram showing an overview of the image forming system in the second embodiment. Referring to FIG. 9, the image forming system 1 in the second embodiment is different from the image forming system 1 in the first embodiment shown in FIG. 1 in that MFPs 100A, 100B are added. The other configuration is the same as that of the image forming system 1 in the first embodiment. Thus, a description thereof will not be repeated. The hardware configuration and the functions of the MFPs 100A, 100B are the same as the hardware configuration and the functions of the MFP 100.

In the cloud server 200, application programs that control the respective MFPs 100, 100A, 100B are installed, and the application programs are registered in association with predetermined instructions. Further, the cloud server 200 executes the application programs associated with the instructions specified based on the speech uttered by a user.

Here, a print instruction is associated with a third application program, and a fourth application program is associated with a stop instruction, by way of example. The third application program defines a process of allowing any one of the MFPs 100, 100A, 100B to execute a print job, and the fourth application program defines a process of stopping the print job in execution by any one of the MFPs 100, 100A, 100B.

For example, in the third application program, a location for storing a print job and a device for executing the print are registered in advance with respect to a user. In this case, when the user and the print instruction are specified based on the speech collected by the smart speaker 11, the cloud server 200 executes the third application program in accordance with the specified print instruction. In this case, the cloud server 200 allows the device, which is registered with respect the user, out of the MFPs 100, 100A, 100B to execute the print job that is stored in the location registered with respect to the user who is specified based on the speech collected by the speaker 11. For example, a predetermined folder in the cloud server 200 is registered as the location for storing the print job with respect to a user A, and the MFP 100 is registered as the device that executes the print, by way of example. In the case where the user A utters the print instruction to the smart speaker 11, the cloud server 200 specifies the user A and the print instruction based on the speech collected by the smart speaker 11. Then, the cloud server 200 executes the third application program associated with the print instruction and transmits the print job stored in the predetermined folder in the cloud server 200 registered with respect to the user A to the MFP 100 that is registered with respect to the user A, thereby allowing the MFP 100 to execute the print job. Therefore, when producing the print job using the PC 13, storing the print job in the predetermined folder in the cloud server 200, and then inputting the print instruction to the smart speaker 11 by speech, the user A can allow the MFP 100 to execute the print job. In this case, the print job includes user identification information for identifying the user who has input the print instruction.

The MFPs 100, 100A, 100B are registered in advance in association with the fourth application program. In this case, the cloud server 200 executes the fourth application program in accordance with a stop instruction specified by the speech collected by the smart speaker 11, and transmits a stop signal for stopping execution of the print job to any one or all of the MFPs 100, 100A, 100B. In the case where specifying the stop instruction based on the speech collected by the smart speaker 11, when being able to specify the user based on the speech, the cloud server 200 transmits the stop signal including the user identification information for identifying the specified user to all of the respective MFPs 100, 100A, 100B. In the case where specifying the stop instruction based on the speech collected by the smart speaker 11, when being unable to specify the user based on the speech, the cloud server 200 transmits a stop signal not including the user identification information to the device, which is selected by the user, out of the MFPs 100, 100A, 100B.

In the case where specifying the stop instruction, when being able to specify the user based on the speech, the cloud server 200 transmits the stop signal including the user identification information for identifying the specified user to all of the respective MFPs 100, 100A, 100B. Thus, each of the MFPs 100, 100A, 100B performs the operation similar to the operation described in the first embodiment in relation to the MFP 100. Specifically, if the job in execution is not associated with additional information, execution of the job is not stopped. However, if the job in execution is associated with additional information, execution of the job is stopped. Further, because the stop signal includes the user identification information, even when the job in execution is not associated with the additional information, if the user identification information included in the job in execution is the same as the user identification information included in the stop signal, execution of the job is stopped. Further, because the stop signal includes the user identification information, in the case where the job in execution is associated with the additional information, when the user identification information included in the job in execution is different from the user identification information included in the stop signal, the MFP 100 does not stop the execution of the job.

Further, in the case where specifying the stop instruction, when being unable to specify the user based on the speech, the cloud server 200 transmits a stop signal not including user identification information to the device selected by the user from among the MFPs 100, 100A, 100B. Therefore, in the case where the MFP 100 is selected, for example, the MFP 100 receives the stop signal not including the user identification information. If the job in execution is associated with additional information, the MFP 100 stops the execution of the job. If the job in execution is not associated with additional information, the MFP 100 does not stop the execution of the job.

With the method of allowing the user to select one of the MFPs 100, 100A, 100B, the smart speaker 11 can be used as a user interface, for example. Specifically, the cloud server 200 controls the smart speaker 11, and allows the smart speaker 11 to output the message by speech to prompt selection out of the MFPs 100, 100A, 100B. When the user utters the device name of any one of the MFPs 100, 100A, 100B, the cloud server 200 specifies the device based on the speech collected by the smart speaker 11, and transmits the stop signal to the specified device.

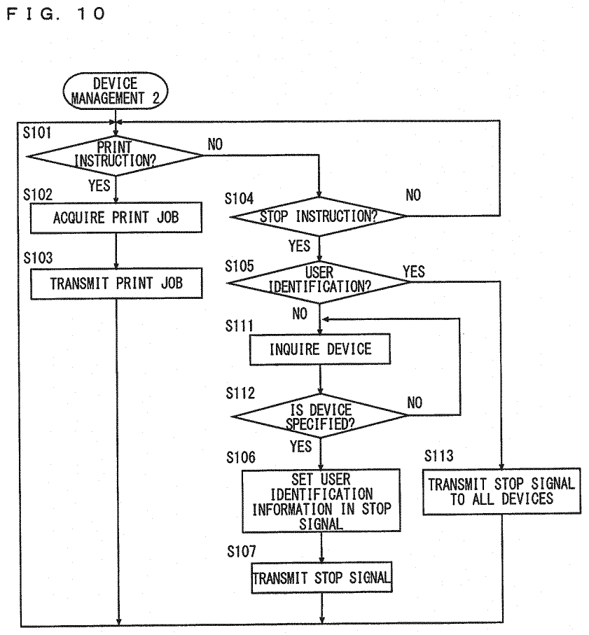

FIG. 10 is a flow chart showing one example of a flow of a device management process in the second embodiment. The device management process is performed by the CPU 201 when the CPU 201 included in the cloud server 200 executes the third application program and the fourth application program. Referring to FIG. 10, the device management process in the second embodiment is different from the device management process in the first embodiment shown in FIG. 4 in that the step S111 and the step S112 are added between the step S105 and the step S104, and that the step S113 is added in the case of “NO” in the step S105. The other processes are the same as the processes shown in FIG. 4. Therefore, a description thereof will not be repeated.

In the step S105, if the user is identified, the process proceeds to the step S113. If not, the process proceeds to the step S111. In the step S113, a stop signal is transmitted to all of the registered devices, i.e. the respective MFPs 100, 100A, 100B in this example, and the process returns to the step S101.

In the step S111, the CPU 201 inquires which one of the registered MFPs 100, 100A, 100B is selected to the user. The CPU 201 controls the smart speaker 11, and allows the smart speaker 11 to output the message prompting the selection from among the MFPs 100, 100A, 100B by speech. Then, the CPU 201 determines whether the device that has been selected by the user is specified. When the user utters the device name of any one of the MFPs 100, 100A, 100B, the cloud server 200 specifies the device based on the speech collected by the smart speaker 11. If the device selected by the user is specified, the process proceeds to the step S106. If not, the process returns to the step S111. The stop signal transmitted in the step S107 includes the user identification information.

In the case where a plurality of devices are selected by the user, a stop signal in which the user identification information is set may be transmitted to each of the plurality of selected devices.

As described above, the MFP 100 in the present embodiment functions as an image forming apparatus, and does not stop the job, which is input not by speech, by a stop instruction given by speech. The user who inputs a job by speech is likely to input a stop instruction by speech, and the user who inputs a job not by speech is unlikely to input a stop instruction by speech. Therefore, execution of the job that is input not by speech is prevented from being stopped by the stop instruction given by speech, whereby the job that is input not by speech is removed from the jobs to be controlled in response to the stop instruction given by speech, and execution of the job that is input by another user can be prevented from being stopped. Thus, the number of erroneous operations to be performed in the case where the job is controlled based on speech can be reduced.

Further, the MFP 100 stops execution of the job, which is input by speech, by the instruction given by speech, so that the user who inputs the job by speech can stop the execution of the input job by speech.

Further, in the case where a job that is input not by speech is set in a wait line, the MFP 100 executes the job after stopping a job that is input by speech. Therefore, a subsequent job is executed early, so that the wait time for another user who has instructed execution of the subsequent job can be shortened.

Further, even in the case where a job is input by speech, when the job is input by a user different from the user who has input the stop instruction by speech, the MFP 100 does not stop the execution of the job. Therefore, the MFP 100 does not stop the execution of the job that is input by speech uttered by the user who is different from the user who has given an instruction by speech, execution of the job that is input by another user can be prevented from being stopped.

Further, even in the case where the job is input not by speech, when the job is input by the same user who has input the stop instruction by speech, the MFP 100 stops the execution of the job. Therefore, the user who has input the stop instruction by speech can stop the execution of the job input by the user.

In the image forming system 1 in the second embodiment, in the case where the user who has input the stop instruction by speech cannot be identified, the stop instruction is transmitted to the device selected by the user from among the MFPs 100, 100A, 100B. Therefore, the stop instruction can be prevented from being transmitted to the device in which the user has not input a job, and execution of a job input by another user can be prevented from being stopped erroneously.

Although the present invention has been described and illustrated in detail, it is clearly understood that the same is by way of illustrated and example only and is not to be taken by way limitation, the scope of the present invention being interpreted by terms of the appended claims.

What is claimed is:

1. An image forming apparatus includes a hardware processor,
the hardware processor
determining a job, and
in the case where the job is to be controlled in response to acceptance of an instruction to control the job, even when the instruction to control the job is accepted based on speech, if the job is determined not based on speech, not controlling the job.

2. The image forming apparatus according to claim 1, wherein
the hardware processor, in the case where the instruction is accepted based on speech, when the job is determined based on speech, controls the job.

3. The image forming apparatus according to claim 2, wherein
the hardware processor, in the case where the instruction indicates a stop of execution of the job, executes the job to be determined next after stopping the execution of the job.

4. The image forming apparatus according to claim 2, wherein
the hardware processor
identifies a user based on speech,
associates a user who has instructed determination of the job with the job, and in the case where the job is to be controlled in response to acceptance of an instruction to control the job, even when the job is determined based on speech, if the job is not associated with the user who has been identified based on the speech by which the instruction is given, does not control the job.

5. The image forming apparatus according to claim 1, wherein
the hardware processor
identifies a user based on speech,
associates a user who has instructed determination of the job with the job, and
in the case where the job is to be controlled in response to acceptance of an instruction to control the job, even when the job is determined not based on speech, if the job is associated with the user who has been identified based on speech by which the instruction is given, controls the job.

6. The image forming apparatus according to claim 1, wherein
the hardware processor, in the case where the determined job is produced by an information processing apparatus, acquires additional information, indicating that the job has been produced based on speech, together with the job from the information processing apparatus.

7. An image forming system comprising:
a plurality of image forming apparatuses; and
an instruction acceptor that accepts an instruction, wherein
a hardware processor included in each of the plurality of the image forming apparatuses determines a job, and
in the case where the job is to be controlled in accordance with the accepted instruction, when the instruction is accepted based on speech, if the job is determined not based on speech, does not control the job.

8. The image forming system according to claim 7, comprising a second hardware processor, wherein
the second hardware processor
identifies a user based on speech,
in the case where the instruction is accepted based on speech, when a user cannot be identified based on speech by which the instruction is given, determines a target device from among the plurality of image forming apparatuses, and
the hardware processor included in the target device, in the case where the job is to be controlled in response to acceptance of an instruction to control the job, when the instruction is accepted based on speech, if the job is determined based on speech, controls the job, and
the hardware processor included in a non-target device, which is not the target device, out of the plurality of image forming apparatuses, in the case where the job is to be controlled in response to acceptance of an instruction to control the job, does not control the job based on the instruction.

9. The image forming system according to claim 8, wherein
the second hardware processor determines one or more image forming apparatuses that are selected by a user from among the plurality of image forming apparatuses as the target devices.

10. A control method performed in an image forming apparatus, including:
a determination step of determining a job, and
a job control step of controlling the job in response to acceptance of an instruction to control the job, wherein
the job control step, in the case where the instruction is accepted based on speech, when the job is determined not based on speech, includes not controlling the job.

11. The control method according to claim 10, wherein
the job control step, in the case where the instruction is accepted based on speech, when the job is determined based on speech, includes controlling the job.

12. The control method according to claim 10, further including an execution step of executing the job, wherein
the job control step, in the case where the instruction indicates a stop of execution of the job, includes executing the job to be determined next after stopping the execution of the job.

13. The image forming apparatus according to claim 11, further including a user identification step of identifying a user based on speech, wherein
the determination step includes associating a user who has instructed determination of the job with the job, and
the job control step, even in the case where the job is determined based on speech, if the job is not associated with the user who has been identified based on speech by which the instruction is given, includes not controlling the job.

14. The control method according to claim 10, further including
a user identification step of identifying a user based on speech, wherein
the determination step includes associating a user who has instructed determination of the job with the job, and
the job control step, even in the case where the job is determined not based on speech, when the job is associated with the user who has been identified based on speech by which the instruction is given, includes controlling the job.

15. The control method according to claim 10, further including an additional information acquiring step of, in the case where the determined job is produced by an information processing apparatus, acquiring additional information, indicating that the job has been produced based on speech, together with the job from the information processing apparatus.

16. A control method performed in an image forming system including a plurality of image forming apparatuses and an instruction acceptor that accepts an instruction, including allowing each of the plurality of image forming apparatuses to perform:
a determination step of determining a job; and
a job control step of controlling the job in accordance with the accepted instruction, wherein
the job control step, in the case where the instruction is accepted based on speech, when the job is determined not based on speech, includes not controlling the job.

17. The control method performed in the image forming system according to claim 16, further including:
a user identification step of identifying a user based on speech, and
a device determination step of, in the case where the instruction is accepted based on speech, when a user cannot be identified based on speech by which the instruction is given, determining a target device from among the plurality of image forming apparatuses, wherein
the job control step performed in the target device, in the case where the instruction is accepted based on speech, when the job is determined based on speech, includes controlling the job, and
the job control step that is performed in a non-target device, which is not the target device, out of the plurality of image forming apparatuses, includes not controlling the job based on the instruction.

18. The control method according to claim 17, wherein
the device determination step includes determining one or more image forming apparatuses that are selected by a user from among the plurality of image forming apparatuses as the target device.

19. A non-transitory computer-readable recording medium encoded with a control program executed by a computer controlling an image forming apparatus,
the computer, by executing the control program,
determining a job, and
in the case where the job is to be controlled in response to acceptance of an instruction to control the job, when the instruction is accepted based on speech, if the job is determined not based on speech, not controlling the job.
